(19) United States
(12) Patent Application Publication
(10) Pub. No.: US 2014/0309122 A1
(43) Pub. Date: Oct. 16, 2014

(54) KNOWLEDGE-DRIVEN SPARSE LEARNING APPROACH TO IDENTIFYING INTERPRETABLE HIGH-ORDER FEATURE INTERACTIONS FOR SYSTEM OUTPUT PREDICTION

(71) Applicant: NEC Laboratories America, Inc., Princeton, NJ (US)

(72) Inventors: Renqiang Min, Plainsboro, NJ (US); Yanjun Qi, Princeton, NJ (US); Salim Akhter Chowdhury, Princeton, NJ (US)

(73) Assignee: NEC Laboratories America, Inc., Princeton, NJ (US)

(21) Appl. No.: 14/243,920

(22) Filed: Apr. 3, 2014

Related U.S. Application Data
(60) Provisional application No. 61/810,814, filed on Apr. 11, 2013.

(51) Int. Cl. G06F 19/24; G06N 99/00

(52) U.S. Cl. CPC G06F 19/24; G06N 99/005
USPC 506/8; 706/12; 702/19

(57) ABSTRACT

Systems and methods are disclosed for Knowledge-Driven Sparse Learning to Identify Interpretable High-Order Feature Interactions. This is done by generating one or more functional groups from gene features and gene and protein interaction grouping; selecting informative genes and functional interactions that exhibit differential patterns for the target disease and to generate a reduced feature space; and searching exhaustively on the reduced feature space by examining all possible pairs of interacting features (and possibly higher-order feature interactions) to identify combination of markers and complex patterns of feature interactions that are informative about the phenotypes in a sparse learning framework to select informative interactions and genes.

The present application claims priority to Provisional Application Ser. 61/810,814, filed Apr. 11, 2013, the content of which is incorporated by reference.

### BACKGROUND

In certain biomedical field, disrupted or abnormal gene interactions responsible for many complex human diseases including cancers can be identified through their expression changes correlating with the progression of a disease. However, the examination of all possible combinatorial interactions between gene features in a genome-wide case-control study is computationally infeasible as the search space is exponential in nature.

For example, one task of cancer diagnosis uses molecular signature, such as gene expression measured using microarray experiments or protein expression values measured in blood. Differential analysis of gene expression helps identification of individual genes that show altered behavior in the phenotype of interest. Although single gene markers provide valuable information about the process under study, a major problem with these markers is that they offer limited insight into the complex interplay among molecular factors responsible for progression of complicated diseases, like cancers. However, the identification of groups of genes that show differential behavior in the manifestation of complex phenotypes is computationally infeasible due to the combinatorial nature of the problem. For instance, for a set of 30,000 genes, there are about 4500 million possible quadratic gene-gene interactions in the search space. These problems also exist in other applications, for example in information retrieval to deal with semantically meaningful high-order word and phrase interactions for ranking documents or webpages.

### SUMMARY

In one aspect, a system can show differential behavior for diagnosing a target disease using molecular signatures. Gene Ontology and Overlapping Group Lasso techniques are used to identify biologically relevant informative gene groups and physical gene interaction groups that exhibit differential patterns for the studied disease. In a subsequent stage, the system searches exhaustively on this reduced feature space by examining all possible pairs of interacting features to identify the combination of markers and complex patterns of feature interactions that are informative about the phenotypes in a sparse learning framework.

In another aspect, a system called QUIRE takes as input, gene or protein expression levels of a set of samples, disease status of those samples and physical interactions amongst the gene products. Then it uses gene ontology based functional annotation to group the genes and cluster the interaction network. Overlapping group lasso is run next on the expression and interaction space to identify informative set of genes and interactions. QUIRE then enumerates all pairwise binary interactions amongst the selected gene features. Finally the proposed novel objective function is applied on the selected single gene features, the informative protein protein interactions and the quadratic interactions amongst these genes to identify the final set of interactions and gene markers.

In yet another aspect, a system for disease detection includes the following operation:

1. Functional group generation:

a) QUIRE groups the p input gene features into q overlapping functional categories according to the existing Gene Ontology (GO) based functional annotations, such as Cellular Colocalization (CC), Molecular Function (MF), and Biological Process (BP).

b) QUIRE clusters the given interaction network (i.e. PPI) into subsets of overlapping gene products based on GO functional annotations, CC, MF and BP.

2. Informative genes and functional interactions selection:

a) Given the GO functional grouping of input gene features, Overlapping Group Lasso is run to select m top discriminative genes for disease status prediction according to the absolute values of the learned weights of gene features.

b) Overlapping group lasso is run on the clustered interaction network to select informative groups of protein-protein interactions. In this case, each cluster is considered as a group and quadratic interactions (discussed later) among the interacting proteins in a group are used as expression.

3. Selection of most informative interactions and genes:

QUIRE first enumerates all possible quadratic feature interactions among the informative genes selected at step 2(a). Then it takes these quadratic interactions, single informative gene features and the informative functional interactions identified at step 2(b) as input and it outputs the final selected gene interactions and single genes as biomarkers.

Advantages of the system may include one or more of the following. The system can find meaningful quadratic interactions between informative input features for system can output prediction, especially for early cancer diagnosis and biomarker discovery from patient blood samples. The system is scalable to huge-dimensional datasets that are common in biomedical applications and information retrieval. The approach performs significantly better than the state-of-the-art feature selection methods such as Lasso and SVM for biomarker discovery while selecting a smaller number of features, and this approach can capture discriminative interactions with high relevance to cancer progression. When applied to genome-wide microarray experimental data, the system can be used to help prioritize Somamer design for blood-based cancer diagnosis. The system can also be applied to blood-based experimental data with a great potential to impact the field of practical medical diagnosis. Other applications can be used as well, for example, the system can be applied to information retrieval in a similar way for document ranking, sentiment analysis, and paraphrase analysis.

Other advantages may include one or more of the following. The system enables identification of a sparse set of informative features and can handle correlated features well on the feature level. The group structure between gene features is quite common and contains essential prior knowledge on the relations amongst the features. Predefined group structure can be imposed on the input features for feature selection, and the system selectively outputs relevant features. The system can consider multiple gene features for prediction for better disease status prediction and biomarker discovery and can capture complex combinatorial relationship amongst the protein features.

### BRIEF DESCRIPTION OF THE DRAWINGS

FIG. 1 shows an exemplary process for Knowledge-Driven Sparse Learning for identifying Interpretable High-Order Feature Interactions and for System Output Prediction.

FIG. 2 shows an exemplary computer for Knowledge-Driven Sparse Learning for identifying Interpretable High-Order Feature Interactions and for System Output Prediction.

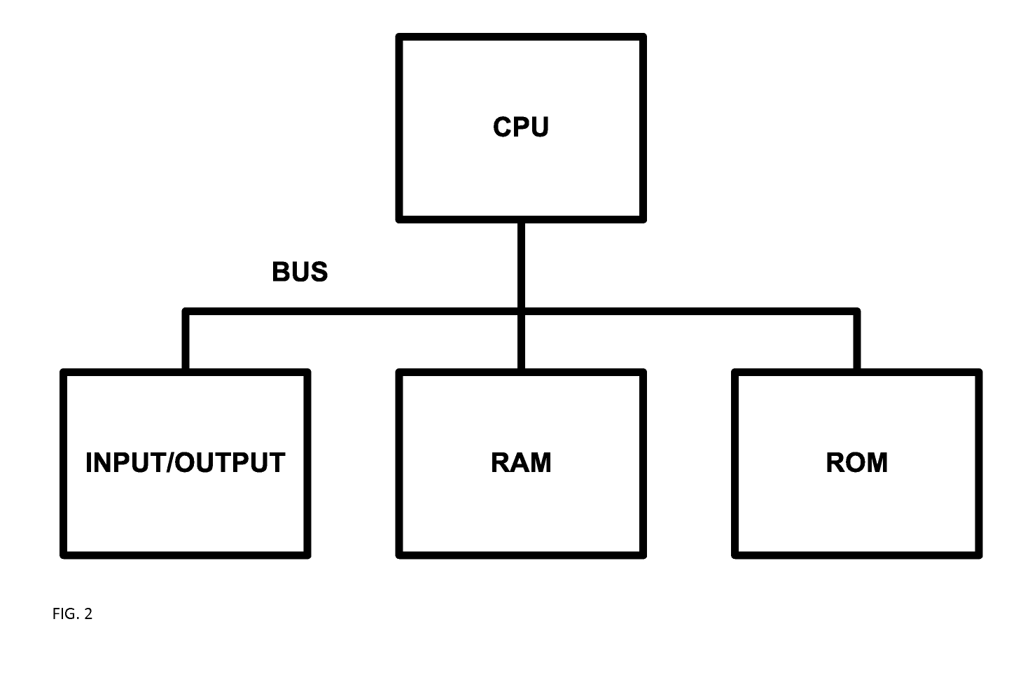

### DESCRIPTION

For cancer diagnosis and biomarker discovery, the system can identify the complex combinations of pairwise interactions among the genes that can help in (1) better diagnosis and prognosis of different types of cancer, and (2) gain novel insights into the mechanistic basis of the diseases. Since the total number of possible pairwise human gene interactions is huge, it is computationally infeasible to examine all possible combinatorial combinations of them when trying to understand their relevance to the phenotype under consideration. Due to the “High Dimensionality” issue, the first target is to utilize existing biological knowledge to reduce the dimensionality of the search space in such a manner that it enables the system to identify informative interacting gene partners in a reasonable limit of time and memory space. This reduced search space then enables the system to look for combinations of interacting pairs of informative genes in a more practical sparse learning setting.

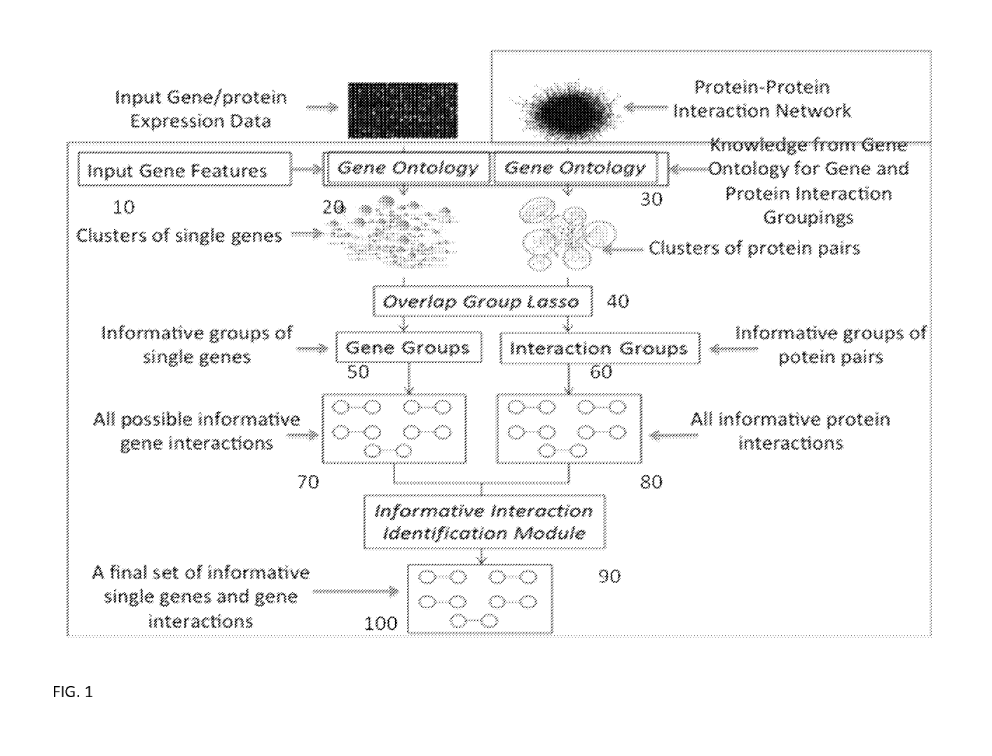

FIG. 1 shows an exemplary process for Knowledge-Driven Sparse Learning for identifying Interpretable High-Order Feature Interactions and for System Output Prediction. In this process, input gene features 10 is provided to a gene ontology which generates clusters of single genes 20. Additionally, knowledge for gene and protein interaction groupings is provided to generate clusters of protein pairs 30. An Overlap Group Lasso process receives the clusters of single genes 20 and clusters of protein pairs 30 and generates gene groups 40 and interaction groups 60. The process the determines all possible informative gene interactions 70 and all informative protein interactions 80 and provide the results to an informative interaction identification module 90. A final set of informative single gene and gene interaction data 100 is then generated.

In an exemplary 2-stage embodiment named as QUIRE, i.e. to detect QUadratic Interactions among infoRmativefEatures, the system can show differential behavior for diagnosing a target disease using molecular signatures. In the first stage, Gene Ontology and Overlapping Group Lasso techniques are used to identify biologically relevant informative gene groups and physical gene interaction groups that exhibit differential patterns for the studied disease. Then in the second stage, the system searches exhaustively on this reduced feature space by examining all possible pairs of interacting features to identify the combination of markers and complex patterns of feature interactions that are informative about the phenotypes in a sparse learning framework.

In one implementation, QUIRE is incorporates all possible complementary biological knowledge into an L1-regularized optimization problem with both single features and all possible high-order feature interactions as input to reduce search space over high-order feature interactions. By restricting discriminative gene interactions to happen only between genes in some informative gene groups, the system can use existing functional annotations of input genes to identify these groups thereby to throw away a lot of interaction terms during the optimization. In addition, available physical interactions between the protein products of input genes can also be used to cut the search space, although discriminative gene feature interactions for prediction do not always necessarily correspond to physical interactions. QUIRE takes the expression profile of n samples over p genes (proteins), the physical interactions among the genes products (i.e. protein-protein interaction network) and the disease status of these samples as input, and it outputs a (small) set of discriminative genes and gene interactions with corresponding learned weights for predicting the disease status of any incoming test sample. When computing feature interactions as features, the system can take products of pairwise features first and then the system can perform normalization, which often results in better performance than products of normalized feature values on expression datasets.

In information retrieval, the system can use existing word ontology databases such as WordNet to group word features to identify possible high-order word interactions, and the system can also simply incorporate phrases (common word combinations) from dictionary as informative features for document ranking and some other document classification tasks.

QUIRE can identify discriminative complex interactions among informative gene features for cancer diagnosis. QUIRE works in two stages, where it first identifies functionally relevant feature groups for the disease and, then explores the search space capturing the combinatorial relationships among the genes from the selected informative groups. QUIRE can explore the differential patterns and the interactions among informative gene features in three different types of cancers, Renal Cell Carcinoma (RCC), Ovarian Cancer (OVC) and Colorectal Cancer (CRC). Experimental results show that QUIRE identifies gene-gene interactions that can better identify the different cancer stages of samples and can predict CRC recurrence and death from CRC more successfully, as compared to other state-of-the-art feature selection methods.

The system operates by selecting a small number of features relevant to the problem under study. When a set of features are highly correlated to each other, Lasso selects one from that set randomly, ignoring others. So, in our current setting, there is a possibility that Lasso leaves out biologically relevant genes from its set of selected informative features.

Considering a linear regression setting for a data set D containing n observations (x⁽ⁱ⁾,y⁽ⁱ⁾) with response variable yεR and feature vector xεR^{p}, where iε{1, . . . , n}, and where features are standardized with zero mean and unit standard deviation and the y s are centered in D, the Lasso approach optimizes the following objective function,

$$𝓁 ( w ) = {\sum }_{i = 1}^{n} {( {y}_{i} - {\sum }_{j = 1}^{p} {w}_{j} {x}_{j}^{i} )}^{2} , \\ {𝓁}_{lasso} ( w ) = 𝓁 ( w ) + λ {\sum }_{j = 1}^{p} \vert {w}_{j} \vert , \qquad ( 1 )$$

where l(w) is the loss function of linear regression, and w is the weight parameter. The l₁ norm penalty in lasso induces sparsity in the weight space for selecting features. The sum of the least squared errors and the l₁ norm are convex functions with respect to the weights w, and Lasso-penalized linear regression has global optimum for any fixed penalty coefficient λ.

Lasso has global optimum, which can be found by any convex optimization technique. The coordinate descent approach sets the gradient of the loss function lₗₐₛₛₒ(w) to 0 to solve each weight wⱼ iteratively, and it is among one of the most computationally efficient methods.

$${w}_{j} = {S ( \frac{1}{n} {\sum }_{i = 1}^{n} {x}_{j}^{( i )} ( {y}^{( i )} - {\sum }_{k \neq j} {w}_{k} {x}_{j}^{( i )} ) , λ )}_{+} , \qquad ( 2 )$$

where S(z,λ) is a soft-thresholding operator. The value of S(z,λ)₊ is z−λ if z>0 and λ<|z|, z+2 if z<0 and λ<|z|, and 0 if λ|z|.

To capture any prior information on possible group structures among the features. Group Lasso uses l_{2,1} penalty to select groups of input features which are partitioned into non-overlapping groups. The group penalty is the sum of the l₂ norm on the features belonging to the same group. Overlapping Group Lasso Jacob2009 extends Group Lasso to handle groups of features with overlapping group members by duplicating input features belonging to multiple groups in the design matrix. Because many real applications involve overlapping feature groupings, Overlapping Group Lasso is a more natural choice than Group Lasso. If partition p features in data set D into q overlapping groups G={g₁, g₂, . . . , g_{q}}, the following objective function is minimized,

$${𝓁}_{oglasso} = 𝓁 ( w ) + λ {\sum }_{g ∈ G} {\vert \vert {w}_{g} \vert \vert}_{2} , \qquad ( 3 )$$

where λ is the regularization parameter, w_{g} denotes the set of weights associated with features in group g, and ∥•λ₂ is the Euclidean norm. The above optimization problem is separable, so block coordinate descent can be used to optimize the weights associated with each group g separately. The subgradient of the optimization takes the following form,

$$- {\sum }_{i = 1}^{n} {x}_{g}^{( i ) T} ( {y}^{( i )} - {\sum }_{{g}^{′}} {w}_{{g}^{′}} {x}_{{g}^{′}}^{( i )} ) + λ \frac{{w}_{g}}{‖ {w}_{g} ‖} = 0 ; ∀ g ∈ G . \qquad ( 4 )$$

Therefore, if ∥Σᵢ₌₁ⁿx_{g}^{(i)T}(y⁽ⁱ⁾−Σ_{g′≠g}w_{g′}x_{g′}⁽ⁱ⁾)∥<λ, then w_{g}=0; otherwise, w_{g} can be obtained by solving several one-dimensional optimization problems based on coordinate descent. In details, let Z⁽ⁱ⁾=x_{g}⁽ⁱ⁾=(Z₁⁽ⁱ⁾, . . . , Zₖ⁽ⁱ⁾), w_{g}=θ=(θ₁, . . . , θₖ), and residual r⁽ⁱ⁾=y⁽ⁱ⁾−Σ_{g′≠g}w_{g′}x_{g′}⁽ⁱ⁾, then θⱼs of w_{g} can be solved by minimizing the following objective function,

$$\frac{1}{2} {\sum }_{i = 1}^{n} {( {r}^{( i )} - {\sum }_{j = 1}^{k} {Z}_{j}^{( i )} {θ}_{j} )}^{2} + λ {‖ θ ‖}_{2} . \qquad ( 5 )$$

The final solution of the overlapping group lasso is obtained by iterating the above optimization procedure over each feature group g until convergence.

Although considering grouping structure among input features is very important for feature selection, Overlapping Group Lasso only encourages sparsity at the feature group level and there is no sparsity penalty within feature groups. Therefore, Overlapping Group Lasso often outputs a much larger number of selected features than Lasso. Furthermore, Lasso and Overlapping Group Lasso only consider single gene features for prediction, which is very limited for disease status prediction and biomarker discovery.

For cancer diagnosis and biomarker discovery from blood samples or tissue samples, the system considers all possible combinations of single gene features and quadratic gene interaction features. The system optimizes the following optimization problem to identify discriminative features given the dataset D,

$$𝓁 ( w , U ) = {\sum }_{i = 1}^{n} {( {y}^{( i )} - {\sum }_{j = 1}^{p} {w}_{j} {x}_{j}^{( i )} - {\sum }_{j = 1}^{p - 1} {\sum }_{k = j + 1}^{p} {U}_{jk} {x}_{j}^{i} {x}_{k}^{i} )}^{2} + {λ}_{1} {\sum }_{j = 1}^{m} \vert {w}_{j} \vert + {λ}_{2} {\sum }_{j = 1}^{p - 1} {\sum }_{k = j + 1}^{p} \vert {U}_{jk} \vert . \qquad ( 6 )$$

However, the above model has O(p²) features and is not applicable to genome-wide biomarker discovery studies. Provided that the training data is often very limited, it is almost impossible to identify the discriminative single or quadratic interaction features by solving the above optimization problem. We propose QUIRE (QUadratic Interactions among infoRmative fEatures) to address these challenges, which is based on Overlapping Group Lasso and Lasso. And it takes advantage of both of these feature selection methods.

The underlying idea of QUIRE is to incorporate all possible complementary biological knowledge into the above infeasible optimization problem to reduce search space. By restricting discriminative gene interactions to happen only between genes in some informative gene groups, we can use existing functional annotations of input genes to identify these groups thereby to throw away a lot of interaction terms during the optimization. In addition, available physical interactions between the protein products of input genes can also be used to cut the search space, although discriminative gene feature interactions for prediction do not always necessarily correspond to physical interactions. The general working model of QUIRE is shown in FIG. 1. In details, QUIRE takes the expression profile of n samples over p genes (proteins), the physical interactions among the genes products (i.e. protein protein interaction network) and the disease status of these samples as input, and it outputs a (small) set of discriminative genes and gene interactions with corresponding learned weights for predicting the disease status of any incoming test sample. The step by step working model of QUIRE is given below:

1. Functional group generation:

(a) QUIRE groups the p input gene features into q overlapping functional categories according to the existing Gene Ontology (GO) based functional annotations, such as Cellular Colocalization (CC), Molecular Function (MF), and Biological Process (BP).

(b) QUIRE clusters the given interaction network (i.e. PPI) into subsets of overlapping gene products based on GO functional annotations, CC, MF and BP.

2. Informative genes and functional interactions selection:

(a) Given the GO functional grouping of input gene features, Overlapping Group Lasso is run to select m top discriminative genes for disease status prediction according to the absolute values of the learned weights of gene features.

(b) Overlapping group lasso is run on the clustered interaction network to select informative groups of protein-protein interactions. In this case, each cluster is considered as a group and quadratic interactions (discussed later) among the interacting proteins in a group are used as expression.

3. Selection of most informative interactions and genes: QUIRE first enumerates all possible quadratic feature interactions among the informative genes selected at step 2(a). Then it takes these quadratic interactions, single informative gene features and the informative functional interactions identified at step 2(b) as input and it outputs the final selected gene interactions and single genes as biomarkers.

In order to identify the discriminative combinations of single gene features and quadratic interactions among pairwise informative genes, we define our proposed objective function for Lasso as follows,

$$𝓁 ( w , U , R ) = {\sum }_{i = 1}^{n} {( {y}^{( i )} - {\sum }_{j = 1}^{m} {w}_{j} {x}_{j}^{( i )} - {\sum }_{j = 1}^{m - 1} {\sum }_{k = j + 1}^{m} {U}_{jk} {x}_{j}^{i} {x}_{k}^{i} - {\sum }_{l = 1}^{r} {R}_{l} {I}_{l} )}^{2} + {λ}_{1} {\sum }_{j = 1}^{m} \vert {w}_{j} \vert + {λ}_{2} {\sum }_{j = 1}^{m - 1} {\sum }_{k = j + 1}^{m} \vert {U}_{jk} \vert + {λ}_{3} {\sum }_{l = 1}^{r} \vert {R}_{l} \vert , \qquad ( 7 )$$

where j and k index the seed informative genes and l indexes the informative protein protein interactions selected by the Overlapping Group Lasso in the previous step. The objective function contains l₁ penalties at single informative gene level, and pairwise gene interaction and protein interaction level. The intuition behind this formulation is that it captures the interactions that are complementary to the individual informative genes. Because it is computationally infeasible to consider every pair of interaction in a genome wide case control study, QUIRE reduces the search space by using the features that are selected by Overlapping Group Lasso as the informative ones, and then it relies on Lasso with l₁ penalties to identify the discriminative combination of informative individual gene features and gene interaction features, which provides an approximation to the problem of searching an exponential number (O(2^{p+p}^{²})) of all possible combinations of single features and pairwise interaction features.

In one embodiment, the system performs feature standardization before running Lasso or Group Lasso. Instead of using the original quadratic interactions xⱼxₖ between pairwise variables xⱼ and xₖ, the system standardizes xⱼxₖ by g(xⱼxₖ) as input feature, where

$$g ( x ) = \frac{x - μ}{σ} ,$$

and μ and σ are respectively the mean and standard deviation of feature x. As shown below, feature standardization has nice properties when running Lasso, and quadratic feature interactions calculated by g(xⱼxₖ) is more sensible than g(xⱼ)g(xₖ) for biomarker discovery because it does not have weight sharing constraints involving both gene interaction features and single gene features. Moreover, g(xⱼ)g(xₖ) can result in inaccurate calculations because the product of two large negative values for normalized features is a large positive value, which is not desirable in most applications. The advantage of g(xⱼxₖ) over g(xⱼ)g(xₖ) is supported by experimental results. The solution of Lasso-penalized linear regression on standardized input features with one fixed penalty coefficient λ is equivalent to the solution of a Lasso problem on original input features with adaptive penalty coefficients for different weights being λ weighted by the standard deviations of different corresponding original features. Further, the setting of Lasso-penalized linear regression, our proposed quadratic feature interaction g(xⱼxₖ) has different effect compared to g(xⱼ)g(xₖ). g(xⱼxₖ) only constrains original feature interactions xⱼxₖ while g(xⱼ)g(xₖ) results in weight sharing constraints involving both interaction features and single features.

Next, the application of QUIRE by the inventors to cancer is discussed. Cancer is a genetic disease, which originates and develops through a process of mutations. Mutations in individual gene not only disrupts its own function, but also affects its interaction patterns with other genes. As complex diseases like cancer is a result of dysregulation in the interactions among the genes, researchers focus on identifying those relevant interactions to gain more insight into the molecular basis of the disease. On the CRC dataset, QUIRE selects about 120 quadratic interactions on average as informative ones for both CRC recurrence and death from CRC. On the other hand, the average number of markers selected by Overlapping Group Lasso and Lasso on the same prediction tasks are about 1100 and 150 respectively.

An investigation of the pairwise interactions identified by QUIRE on CRC dataset reveals that many of these interactions are indeed relevant to the progression of cancer in general. Some of such interactions identified for prediction of CRC recurrence include JAK2—LYN, Transforming growth factor beta (TGF?\beta)—SMAD, Epidermal growth factor receptor (EGFR)—Caveolin (CAV), TP53—TATA binding protein (TBP), Connective tissue growth factor (CTGF)—Vascular endothelial growth factor (VEGF), Edoglin (ENG)—Transforming growth factor beta receptor (TGF\betaR). Further investigations of the interactions identified by QUIRE might reveal novel gene partners associated with cancer and thus lead to testable hypothesis.

Disturbance in pairwise interactions among the genes affects the pathways in which they are located in. Cancer pathways are a set of pathways dysregulations in which have been shown to be associated with initiation and progression of the disease. The system performs a pathway enrichment analysis where we test if the set of the markers and interactions identified by QUIRE on the CRC dataset reside in the cancer pathways. As part of this experiment, we first use the partner genes identified by QUIRE as part of the informative interactions while predicting CRC recurrence. We use DAVID to identify the statistically significant pathways that are enriched in these genes. An investigation of the enriched pathways returned by DAVID indicates that many of them are indeed responsible for cancer or related to functions dysregulation in which results in cancer. Some of such KEGG pathways include Apoptosis (p-value 4.7×10⁻⁴), Focal adhesion (p-value 3×10⁻³), Cell adhesion molecules (p-value 9.2×10⁻⁴), p53 signaling pathway (p-value 1.3×10⁻²), Gap junction (p-value 1.3×10⁻²), MAPK signaling pathway (p-value 4.5×10⁻²), ErbB signaling pathway (p-value 5.8×10⁻²), Cell cycle (p-value 6.6×10⁻²), Pathways in Cancer (p-value 7.2×10⁻⁴), Colorectal cancer (p-value 10⁻³). Repeating the same analysis on the interacting partners identified by QUIRE while predicting “Death from CRC” result in identification of similar pathways (data not shown here).

Next we use the informative genes and their associated interactions discovered by QUIRE to identify functional modules that might be associated with pathways known to be dysregulated in cancer. We use the web based tool Gene Mania (www.genemania.org) warde2010genemania to identify the statistically significant modules induced by genes and interactions selected by QUIRE. Gene Mania also returns the pathways and functions in which the identified modules are significantly enriched. After investigating these functional modules, we find that many of them are enriched in the well-known cancer pathways. Examples of such pathways include Focal adhesion pathway (p-value 2×10⁻³), Jak-STAT signaling pathway (p-value 3×10⁻²), MAPK signaling pathway (p-value 1.4×10⁻³), NF-kappaB signaling pathway (p-value 4.5×10⁻²), TGF beta signaling pathway (p-value 2.2×10⁻³) and Ras protein signaling pathway (p-value 1.3×10⁻²). Besides, some of the induced modules are functionally enriched in processes disruptions in which are known to be associated with initiation and progression of cancer. Some examples of such functions include Apoptosis (p-value 4.2×10⁻³), Cell migration (p-value 1.3×10⁻³), Response to growth factors (p-value 2.5×10⁻²), Cell cycle checkpoint (p-value 1×10⁻³), Cell-cell adhesion (p-value 3.1×10⁻³) for example.

These experimental results show that QUIRE identifies markers and interactions that complement each other in such a way that they not only help better diagnosis and prognosis of cancer, but also can predict the advanced events of recurrence of cancer and survival after cancer with higher accuracy than other state-of-the-art algorithms. For each of these datasets, identification of informative pairwise interactions using brute force enumerative technique is computationally impractical due to the huge dimensionality of the search space. QUIRE helps reducing this space by a large margin. The total running time of QUIRE is dominated by the Overlapping Group Lasso stage which takes around one hour to identify biologically relevant groups of genes and protein interactions in traditional desktop computers for the types of problems we study. After the dimensionality is reduced, QUIRE exhaustively enumerates all the pairwise interactions and use the protein interactions identified in the previous stage on this low dimensional space in a couple of minutes.

QUIRE, to identify combinatorial interactions among the informative genes in complex diseases, like cancer. The process uses Overlapping Group Lasso to identify functionally relevant gene markers and protein interactions associated with cancer. It then explores the pairwise interactions among these relevant genes within this reduced space exhaustively and the selected pairwise physical protein interactions to discover the combination of individual markers and gene-gene interactions that are informative for prediction of the disease status of interest. The application of QUIRE on three different types of cancer samples collected using two different techniques shows that the instant approach performs significantly better than the state-of-the-art feature selection methods such as Lasso and SVM for biomarker discovery while selecting a smaller number of features, and it also shows that this approach can capture discriminative interactions with high relevance to cancer progression. Further investigations show that QUIRE can identify markers and interactions that have been associated previously with pathways associated with cancer. Moreover, high performance of QUIRE on the CRC dataset suggests that applications of QUIRE on genome-wide microarray experimental data can be used to help prioritize Somamer design for blood-based cancer diagnosis. QUIRE applied to blood-based experimental data has the great potential to impact the field of practical medical diagnosis.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for diagnosing a target disease using molecular signatures, comprising:
generating one or more functional groups from gene features and gene and protein interaction grouping;
selecting informative genes and functional interactions that exhibit differential patterns for the target disease and to generate a reduced feature space; and
searching exhaustively on the reduced feature space by examining all possible pairs of interacting features (and higher-order interactions if possible) to identify combination of markers and complex patterns of feature interactions that are informative about the phenotypes in a sparse learning framework to select informative interactions and genes.

2. The method of claim 1, wherein the functional group generation comprises grouping p input gene features into q overlapping functional categories.

3. The method of claim 2, wherein the functional category is selected according to Gene Ontology (GO) functional annotations.

4. The method of claim 3, wherein the GO functional annotations include one of: Cellular Co-localization (CC), Molecular Function (MF), or Biological Process (BP).

5. The method of claim 2, wherein the functional group generation comprises clustering a given interaction network (i.e. PPI) into subsets of overlapping gene products based on GO functional annotations.

6. The method of claim 1, with a functional grouping of input gene features, applying Overlapping Group Lasso to select m top discriminative genes for disease status prediction according to absolute values of learned weights of gene features.

7. The method of claim 1, with a functional grouping of input gene features, applying Overlapping Group Lasso on a clustered interaction network to select informative groups of protein-protein interactions.

8. The method of claim 7, comprising minimizing an objective function
$${𝓁}_{oglasso} = 𝓁 ( w ) + λ {\sum }_{g ∈ G} {\vert \vert {w}_{g} \vert \vert}_{2} ,$$
where λ is a regularization parameter, w_{g} denotes a set of weights associated with features in group g, and ∥•∥₂ is Euclidean norm.

9. The method of claim 1, comprising enumerating all possible quadratic feature interactions among selected informative genes and providing quadratic interactions, single informative gene features and informative functional interactions to generate selected gene interactions and single genes as biomarkers.

10. The method of claim 1, comprising determining cubic and higher-order interactions by considering interactions of multiple informative features and considering sub-networks in feature interaction networks.

11. A system for diagnosing a target disease using molecular signatures, comprising:
a Gene Ontology module to receive gene features and to receive gene and protein interaction grouping;
an Overlapping Group Lasso module coupled to the Gene Ontology module to identify biologically relevant informative gene groups and physical gene interaction groups that exhibit differential patterns for the target disease and to generate a reduced feature space; and
an information interaction identification module that searches exhaustively on the reduced feature space by examining all possible pairs of interacting features to identify the combination of markers and complex patterns of feature interactions that are informative about the phenotypes in a sparse learning framework.

12. The system of claim 11, wherein the functional group generation comprises grouping p input gene features into q overlapping functional categories.

13. The system of claim 12, wherein the functional category is selected according to Gene Ontology (GO) functional annotations.

14. The system of claim 13, wherein the GO functional annotations include one of: Cellular Co-localization (CC), Molecular Function (MF), or Biological Process (BP).

15. The system of claim 12, wherein the functional group generation clusters a given interaction network (i.e. PPI) into subsets of overlapping gene products based on GO functional annotations.

16. The system of claim 11, with a functional grouping of input gene features, comprising an Overlapping Group Lasso module to select m top discriminative genes for disease status prediction according to absolute values of learned weights of gene features.

17. The system of claim 11, with a functional grouping of input gene features, comprising an Overlapping Group Lasso module on a clustered interaction network to select informative groups of protein-protein interactions.

18. The system of claim 17, wherein each cluster is considered as a group and quadratic interactions among the interacting proteins in a group are used as expression.

19. The system of claim 11, comprising a module for enumerating all possible quadratic feature interactions among selected informative genes and providing quadratic interactions, single informative gene features and informative functional interactions to generate selected gene interactions and single genes as biomarkers.

20. A method for knowledge discovery, comprising:
generating one or more functional groups from a selected set of words;
selecting informative functional interactions from word features to identify possible high-order word interactions with the text; and
selecting most informative interactions and features from phrases (common word combinations) from dictionary as informative features for document ranking and document classification tasks.
